(19) United States
(12) Patent Application Publication
(10) Pub. No.: US 2003/0219538 A1
(43) Pub. Date: Nov. 27, 2003

(54) Spray-coating method and spray-coater

(75) Inventors: Mika Vahakuopus, Helsinki (FI); Vilho Nissinen, Numminen (FI); Seppo Luomi, Jarvenpaa (FI)

Correspondence Address: COHEN, PONTANI, LIEBERMAN & PAVANE, Suite 1210, 551 Fifth Avenue, New York, NY, 10176, US

(73) Assignee: Metso Paper, Inc.

(21) Appl. No.: 10/464,142

(22) Filed: Jun. 18, 2003

Related U.S. Application Data
(63) Continuation of application No. 09/889,346, filed on Aug. 2, 2001, now Pat. No. 6,627,261.
Application No. 09/889,346 is a 371 of international application No. PCT/FI00/00026, filed on Jan. 14, 2000.

(30) Foreign Application Priority Data
Jan. 18, 1999 (FI) 990091

(51) Int. Cl. B05D 3/12; B05D 1/02

(52) U.S. Cl. 427/348; 427/421; 118/325

(57) ABSTRACT

The present invention relates to a method and apparatus for coating a moving paper web (2), in which method the web (2) to be coated is passed to a coater station and the coating is applied to at least one surface of the moving web (2) by means of spraying nozzles (1) disposed in the interior of an enclosing hood (9). The web (2) is supported noncontactingly by means of air jets directed toward at least one side of the web (2).

The present invention relates to a spray-coating method according to the preamble of claim 1 and a spray-coater according to the preamble of claim 15.

Coating paper with a pigment slurry is performed by applying a smooth layer of coating to the surface of a paper web, after which excess water is removed from the web by means of dryers. Over the times, the application and leveling has been carried out with the help of different apparatuses, whose development has been directed by the increasing requirements toward higher quality and productivity, as well as faster web speeds in papermaking machines.

One technique suitable for use in coating a paper web is the so-called spray-coating method that is described, e.g., in the international patent application publication WO 97/13035. In the spray-coating technique the coating mix is applied to the surface of paper web by spraying nozzles in which the coating mix is atomized into small droplets prior to spraying onto the moving paper web. The coat quality can be controlled by adjusting the distance between the spraying nozzle and the web, the spray-jet velocity and the mass rate of spraying. Generally, there must be disposed a number of spraying nozzles in the cross-machine direction to the web travel, because the coverage of the spraying jet emitted by a single nozzle is usually narrower than the width of the web being coated. Typically, there is disposed a number of nozzle rows across the web, perpendicular to the web travel, since a single row of nozzles extending across the web usually fails to provide a coating of a sufficiently high quality. The coating mist not adhering to the web during the coating process can be recovered for reuse. To prevent the coating mist from escaping to the environment, the spraying nozzles are generally located in a closed space such as an enclosing hood.

After the application of the coating, the paper web must be dried in a noncontacting manner because the wet coating is sensitive to mechanical contacts. Generally, the noncontacting drying is carried out using infrared or air impingement dryers. Cylinder dryers can be used only after the coating has attained a sufficiently low moisture content and will not any more adhere to the cylinder.

Conventionally, the coating is applied to the surface of the paper web in several steps, and the paper web may also be subjected to further drying between the successive application steps. This kind of a coater station involving a plurality of applicator/dryer devices requires a lot of space which complicates its integration with a paper machine. One of the problems to be solved in the spray-coating of paper sheet is how to apply the coating emitted from the spraying nozzles so as to attain a uniform coat weight and quality at both the center and the edges of the paper web. Usually, the applied coating layer at the edge areas of the coated paper web tend to be thinner than at the center area of the web, whereby it will be problematic to reach a smooth coat profile up to the web edges. Because the gap between the moving web and the enclosing hood is difficult to seal, it is also impossible to fully prevent the coating mist from escaping to the environment from the hood enclosing the spraying-nozzle assemblies. The spreading of the coating mist to the exterior of the enclosing hood can be reduced by using vacuum suction to remove the coating mist from the interior of the hood and then to separate the coating solids from the recovered coating mist for reuse. However, these kinds of arrangements need a separate filter for recovering coating solids from the mist. The coating mist filling the interior of the enclosing hood also tends to readily adhere to and dry on the surfaces such as the spraying nozzles housed in the interior of the hood.

It is an object of the present invention to provide a novel type of spray application method and apparatus capable of overcoming the above-described problems.

The arrangement according to the invention replaces a roll or wire conventionally used for supporting the web by air jets directable to the surface of the web. Additionally, air jets may be used for drying the coating applied to the web surface. Furthermore, edge deckles are disposed close to the web edge between the spraying nozzles and the paper web that serve to prevent coating sprays discharged from nozzles close to the web edge from reaching the web surface at the edges. With the help of an exhaust nozzle connected to the hood enclosing the spraying nozzles, the interior of the hood is brought to a partial vacuum relative to the ambient pressure thus preventing the coating mist from escaping to the exterior of the hood. Another nozzle connected to the enclosing hood can be used for feeding air or steam into the hood in order to bring the interior temperature and humidity to a level that prevents the coating mist from depositing and drying onto the interior surfaces of the hood. Finally, the interior walls of the hood can be made coolable, whereby the coating mist will condense on the cooled surfaces.

More specifically, the coating method according to the invention is characterized by what is stated in the characterizing part of claim 1.

Furthermore, the applicator apparatus according to the invention is characterized by what is stated in the characterizing part of claim 15.

The invention offers significant benefits.

Air jets employed in the noncontacting supporting of a paper web may replace dryer devices, whereby the dryer section may be made smaller in size and more readily integratable in the layout of the papermaking machine. With the help of the edge deckles according to the invention, the coat profile at the web edges can be made uniform and the cross-machine width of the applied coat can be easily varied. Due to the partial vacuum in the interior of the hood enclosing the nozzles, the coating mist cannot escape from the hood so as to soil equipment exterior to the hood. Furthermore, the adherence and drying of the coating onto the interior parts and surfaces of the hood is reduced thus relaxing the need for their frequent cleaning. Devices specifically intended to the separation of coating solids from the coating mist can be omitted, because of the condensation of solids from the coating mist onto the cooled interior surfaces of the enclosing hood, wherefrom the solids can be recovered for reuse in the coating mix circulation.

In the following, the invention will be examined in greater detail by making reference to exemplifying embodiments illustrated in the appended drawings in which

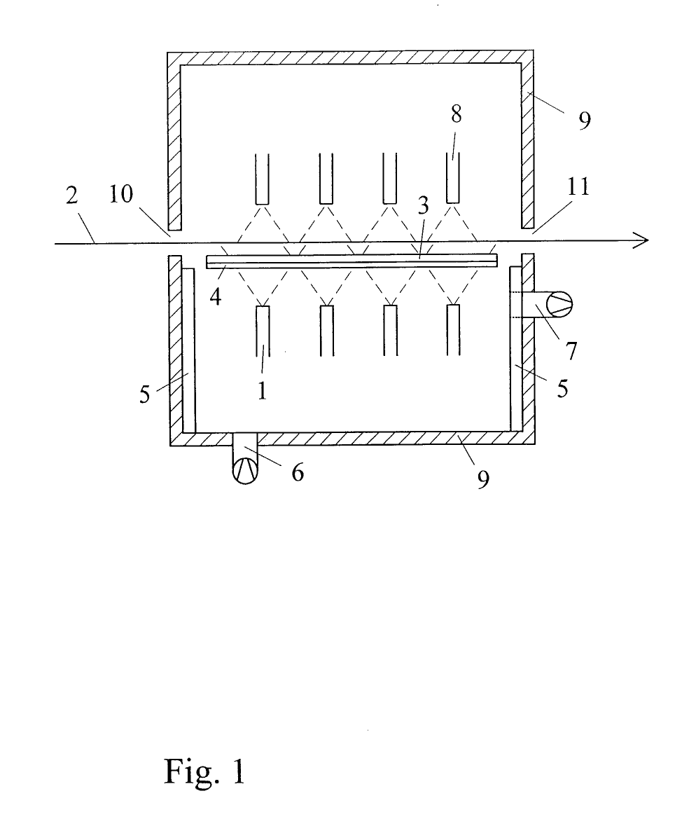

FIG. 1 shows a schematic view of an embodiment of the spray applicator apparatus according to the invention sectioned longitudinally in the travel direction of the paper web.

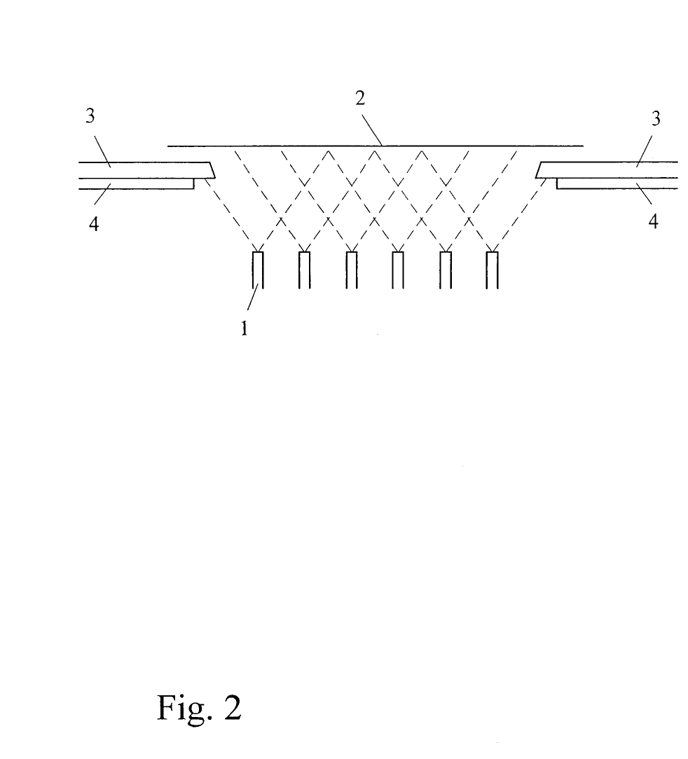

FIG. 2 shows a schematic cross-sectional view of an applicator apparatus according to the invention, particularly for edge deckles disposed between the spraying nozzles and the paper web.

As shown in FIG. 1, a paper web 2 to be coated enters via a horizontal slit 10 the hood 9 enclosing the applicator apparatus. The spraying nozzles 1 are located below the web 2, while the air-jet nozzles 8 serving to support the paper web 2 are disposed above the web 2. The function of the edge deckles 3 shown in FIG. 1 are illustrated in more detail in FIG. 2. The air jet nozzles 8 disposed above the paper web 2 inject air against the paper web 2 at an intensity sufficient to compensate for the impingement force imposed on the lower side of the web 2 by the coating jets emitted by the spraying nozzles 1 and, simultaneously, the air jets serve to dry the coating applied from the spraying nozzles 1 to the web 2. The efficiency of the drying effect can be improved by increasing the temperature of the air discharged from the nozzles 8. Via a suction nozzle 7 connected to the wall of the enclosing hood 9, the interior of the hood 9 is brought to a partial vacuum relative to the ambient pressure thus preventing the coating mist from escaping to the exterior of the hood 9. The interior walls of the hood 9 are cooled with, e.g., chilled water circulating in cooler elements 5, whereby the particulate matter of the coating mist floating in the interior of the hood 9 can be condensed on the wall surfaces and recovered therefrom to the coating mix circulation. The interior temperature and humidity of the hood 9 can be set to desired values by feeding moist air or steam into the hood 9 via an infeed nozzle 6 adapted to the bottom of the hood 9.

In FIG. 2 are shown the spraying nozzles 1 of the applicator apparatus, the paper web 2 to be coated, edge deckles 3 and suction nozzles 4 disposed on the edge deckles 3. When the spraying nozzles 1 apply the coating to the lower surface of the paper web 2, the cross-machine width of the area being coated can be delineated with the help of the edge deckles 3 disposed between the spraying nozzles 1 and the paper web 2. Both the distance of the edge deckles 3 from the surface of the paper web 2 and the cross-machine width of the coated area delineated by the edge deckles 3 can be set to desired values. Thus, coating mist droplets accumulating on the lower surfaces of the edge deckles 3 from the coating sprays emitted by the spraying nozzles 1 can be sucked into nozzles 4 disposed on the edge deckles 3, whereby the droplets are prevented from reaching the surface of the moving paper web 2.

In addition to those described above, the invention may have alternative embodiments.

When the web support is implemented noncontactingly with the help of air jets, the enclosing hood 9 can be made long, whereby a plurality of successive or alternating applicator and dryer stages may be adapted inside the hood 9. The embodiment described above can be modified by disposing spraying nozzles 1 and air-jet nozzles 8 on different sides of the web 2. As required by the travel direction of the web 2, the enclosing hood 9 may be disposed in different positions. Thus, the hood 9 can be oriented, e.g., horizontally or vertically or even in an inclined position. The interior of the enclosing hood 9 can be equipped with deflection devices whose air discharge jets permit the travel path of the web 2 to be directed noncontactingly inside the hood 9. The air jets of the web deflection devices also make it possible to dry the coating applied to the surface of the web 2.

The boundary air layer, which travels on the surface of the moving web 2 and causes disturbance to the application of the coating to the surface of the web 2, can be removed prior to the application point, e.g., with the help of a mechanical doctoring element or by applying air jets reverse to the travel direction of the web 2. Also the exit slit 11 of the enclosing hood 9 can be sealed by air jets blowing toward the slit, reverse to the travel direction of the web 2, said air jets preventing the coating mist particles from escaping to the exterior of the enclosing hood 9 via its exit slit 11. The suction nozzles 4 connected to the edge deckles 3 may also be routed inside the edge deckles 3 or passed along the inner sides of the edge deckles 3 facing the edge of the paper web 2. The applicator apparatus according to the invention can be run with varied kinds of coating mixes. The coating to be applied to the paper web 2 may also be cooled, whereby the portion of the coating mist not adhering to the web 2 will condense more readily onto the cooled walls of the enclosing hood 9. Besides for coating paper sheet, the invention is obviously also suitable for use in the coating of board and other materials of the kind.

1. Method for coating a moving paper web (2), in which method the web (2) to be coated is passed to a coater station and the coating is applied to at least one surface of the moving web (2) by means of spraying nozzles (1) disposed in the interior of an enclosing hood (9), characterized in that the web (2) is supported noncontactingly by means of air jets directed toward at least one side of the web (2).

2. Method according to claim 1, characterized in that the web (2) is supported by heated-air jets for drying the coating applied to the surface of the web (2).

3. Method according to claim 1, characterized in that the coverage of the coating jets directed from the spraying nozzles (1) to the surface of the web (2) is delineated in the cross-machine direction across the web with the help of at least one edge deckle (3) disposed between the spraying nozzles (1) and the paper web (2).

4. Method according to claim 1, characterized in that the interior of the hood (9) is brought to a vacuum in order to prevent the coating mist from escaping to the exterior of the hood (9).

5. Method according to claim 1, characterized in that moist air or steam is fed into the enclosing hood (9).

6. Method according to claim 1, characterized in that the walls of the enclosing hood (9) are cooled in order to cool the coating mist onto the walls thereof.

7. Method according to claim 3, characterized in that coating mix accumulated on the surface of the edge deckle (3) is removed via a nozzle (4) disposed on the edge deckle (3).

8. Method according to claim 1 or 2, characterized in that the coating is applied to the web (2) and the web (2) is dried at least in one step in the interior of the enclosing hood (9).

9. Method according to claim 1, characterized in that the travel direction of the web (2) is deflected noncontactingly by means of at least one deflecting device disposed in the interior of the enclosing hood (9).

10. Method according to claim 1, characterized in that the boundary air layer traveling on the surface of the moving web (2) is removed prior to the application of the coating to the web (2) with the help of a mechanical doctoring element.

11. Method according to claim 1, characterized in that the boundary air layer traveling on the surface of the moving web (2) is removed prior to the application of the coating to the web (2) by applying air jets reverse to the travel direction of the web (2).

12. Method according to claim 1, characterized in that toward the slit (11) of the enclosing hood (9) are directed air jets blowing reverse to the travel direction of the web (2) in order to prevent the coating mist from escaping to the exterior of the enclosing hood (9).

13. Method according to claim 1, characterized in that at least two different kinds of coating mixes are applied to the web (2).

14. Method according to claim 1, characterized in that cooled coating mix is applied to the web (2).

15. Apparatus for coating a moving paper web (2), said apparatus comprising spraying nozzles (1) for applying coating to at least one surface of the paper web (2) and a hood (9) enclosing the spraying nozzles, characterized by injection nozzles (8) located on at least one side of the paper web (2) and serving to support the web (2) in a noncontacting manner by means of air jets.

16. Apparatus according to claim 15, characterized by at least one edge deckle (3) disposed between the spraying nozzles (1) and the web (2).

17. Apparatus according to claim 16, characterized in that the distance between the edge deckle (3) and the web (2) is made adjustable.

18. Apparatus according to claim 16 or 17, characterized in that the cross-machine width of the coated area delineated by the edge deckle (3) on the surface of the web (2) is made adjustable.

19. Apparatus according to claim 15, characterized by at least one deflecting device adapted into the interior of the enclosing hood (9) and serving to deflect the travel direction of the web (2) noncontactingly.

20. Apparatus according to claim 16, characterized in that a suction nozzle (4) is connected to the side of the edge deckle (3) facing the spraying nozzles (1).

21. Apparatus according to claim 16 or 20, characterized in that a suction nozzle (4) is connected to the side of the edge deckle (3) facing the web (2).

22. Apparatus according to claim 16, 20 or 21, characterized in that a suction nozzle (4) is adapted inside the edge deckle (3).
